(19) United States
(12) Patent Application Publication
(10) Pub. No.: US 2025/0190887 A1
(43) Pub. Date: Jun. 12, 2025

(54) SYSTEMS AND METHODS FOR ROBUSTNESS SCHEDULING POLICY FOR MANUFACTURING

(71) Applicant: Samsung Display Co., Ltd., Yongin-si (KR)

(72) Inventors: Shuhui Qu, Fremont, CA (US); Janghwan Lee, Pleasanton, CA (US); Kasra Yazdani, San Jose, CA (US)

(21) Appl. No.: 18/627,353

(22) Filed: Apr. 4, 2024

Related U.S. Application Data
(60) Provisional application No. 63/608,544, filed on Dec. 11, 2023.

(51) Int. Cl. G06Q 10/0631; G06Q 10/0639; G06Q 50/04

(52) U.S. Cl. CPC G06Q 10/0631; G06Q 10/06393; G06Q 50/04

(57) ABSTRACT

According to one or more embodiments of the present disclosure, a manufacturing system may include a processor and a memory storing instructions executed by the processor to cause the processor to compute a difference between a first evaluation metric corresponding to a first scheduling policy and a second evaluation metric. The processor may determine that the computed difference is less than a first threshold, and in response, calculate a second scheduling policy, and determine that the second scheduling policy is greater than a second threshold, and in response, calculate a third scheduling policy such that the third scheduling policy is less than the second threshold.

### CROSS-REFERENCE TO RELATED APPLICATION(S)

This application claims the priority benefit under 35 U.S.C. § 119(e) of U.S. Provisional Application No. 63/608,544, filed on Dec. 11, 2023, the disclosure of which is incorporated by reference in its entirety as if fully set forth herein.

### FIELD

The disclosure generally relates to improving manufacturing productivity. More particularly, the subject matter disclosed herein relates to improvements to systems and methods for robustness scheduling policy for manufacturing.

### SUMMARY

Manufacturing facilities, such as for example, electronic device manufacturing facilities or semiconductor fabrication facilities, often have hundreds of machines in operation, producing hundreds of thousands of diverse products in order to meet production goals and customer demands. Different products may require using multiple machines across the facilities in various orders. Thus, many machines are not only used to produce one product but often use to produce multiple products. Additionally, some products are treated with a higher priority for a faster production, for example, because certain customers may have paid for expedited delivery, or because some products may be in higher demand due to product shortages and/or seasonal demands, etc. Thus, efficient coordination in the operation and utilization of these machines is desired to increase productivity and maximize utilization. Some techniques for facilities operations include utilizing an experienced human (e.g., a manufacturing supervisor or manager) to oversee and coordinate the operation of the machines. However, such human-based scheduling approach relies on the expertise of the person, which can take many years of training to generate reasonable schedules. Furthermore, as the size of the manufacturing facilities grow and produce hundreds of thousands of products across hundreds of different machines, it can become difficult even for the most experienced person to coordinate. Computer automation such as reinforcement Learning (RL)-based scheduling techniques have introduced significant potentials in the realm of scheduling improved techniques. However, as production targets or goals changes, there is a need for such automated techniques adjust and maintain optimal performance. Accordingly, there is a need to evaluate existing scheduling policies to ensure robustness, and if they are no longer optimal, new scheduling policies may be determined.

According to one or more embodiments of the present disclosure, a manufacturing system may include: a processor; and a memory storing instructions executed by the processor to cause the processor to: compute a difference between a first evaluation metric corresponding to a first scheduling policy and a second evaluation metric; determine that the computed difference is less than a first threshold, and in response, calculate a second scheduling policy; determine that the second scheduling policy is greater than a second threshold, and in response, calculate a third scheduling policy such that the third scheduling policy is less than the second threshold, and deploy the third scheduling policy.

The computed difference being less than the first threshold may be indicative of the first scheduling policy being in a first robustness zone based on the second evaluation metric.

The first evaluation metric may correspond to a first set of key performance indicators (KPIs) and the second evaluation metric may correspond to a second set of KPIs.

The instructions may further cause the processor to compute the first scheduling policy, wherein the first scheduling policy may include combining a meta learning policy and a robustness adversarial reinforcement learning (RL) policy.

The first evaluation metric may include a first matrix, and the second evaluation metric may include a second matrix.

The second scheduling policy being greater than the second threshold may be indicative of the second scheduling policy being outside of a second robustness zone.

The second scheduling policy may correspond to a policy that causes a highest performance among other policies.

The calculating the third scheduling policy may include fine-tuning a meta learning policy.

According to one or more embodiments of the present disclosure, a method may include: computing, by a processor, a difference between a first evaluation metric corresponding to a first scheduling policy and a second evaluation metric; determining, by a processor, that the computed difference is less than a first threshold, and in response, calculate a second scheduling policy; determining, by a processor, that the second scheduling policy is greater than a second threshold, and in response, calculate a third scheduling policy such that the third scheduling policy is less than the second threshold; and deploying, by the processor, the third scheduling policy.

The computed difference being less than the first threshold may be indicative of the first scheduling policy being in a first robustness zone based on the second evaluation metric.

The first evaluation metric may correspond to a first set of key performance indicators (KPIs) and the second evaluation metric corresponds to a second set of KPIs.

The method may further include computing, by the processor, the first scheduling policy, the first scheduling policy including combining a meta learning policy and a robustness adversarial reinforcement learning (RL) policy.

The first evaluation metric may include a first matrix, and the second evaluation metric may include a second matrix.

The second scheduling policy being greater than the second threshold may be indicative of the second scheduling policy being outside of a second robustness zone.

The second scheduling policy may correspond to a policy that causes a highest performance among other policies.

The calculating the third scheduling policy may include fine-tuning a meta learning policy.

According to one or more embodiments of the present disclosure a computer-readable medium is described. The computer-readable medium may store instructions that, when executed by one or more processors, cause the one or more processors to perform a method including: computing a difference between a first evaluation metric corresponding to a first scheduling policy and a second evaluation metric; determining that the computed difference is less than a first threshold, and in response, calculate a second scheduling policy; determining that the second scheduling policy is greater than a second threshold, and in response, calculate a third scheduling policy such that the third scheduling policy is less than the second threshold; and deploying the third scheduling policy for a manufacturing system.

The computed difference being less than the first threshold may be indicative of the first scheduling policy being in a first robustness zone based on the second evaluation metric.

The one or more processors may perform a method including computing the first scheduling policy, the first scheduling policy including combining a meta learning policy and a robustness adversarial reinforcement learning (RL) policy, and wherein the first evaluation metric corresponds to a first set of key performance indicators (KPIs) and the second evaluation metric corresponds to a second set of KPIs.

The second scheduling policy being greater than the second threshold may be indicative of the second scheduling policy being outside of a second robustness zone, wherein the second scheduling policy corresponds to a policy that causes a highest performance among other policies, and wherein the calculating the third scheduling policy comprises fine-tuning a meta learning policy.

### BRIEF DESCRIPTION OF THE DRAWINGS

In the following section, the aspects of the subject matter disclosed herein will be described with reference to exemplary embodiments illustrated in the figures, in which:

FIG. 1 depicts an example block diagram of a manufacturing facility.

FIG. 2 is a block diagram of a reinforcement learning (RL) system, according to one or more embodiments of the present disclosure.

FIGS. 3A-3B depict a graphical representation of a meta learning policy, according to one or more embodiments of the present disclosure.

FIG. 4 is a flow chart of a method for evaluating robustness scheduling policies, according to one or more embodiments of the present disclosure.

FIG. 5 is another flow chart of a method for evaluating robustness scheduling policies, according to one or more embodiments of the present disclosure.

FIG. 6 is a block diagram of an electronic device in a network environment, according to one or more embodiments of the present disclosure.

FIG. 7 is a flow chart of a method of executing a schedule according to one or more embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale.

For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

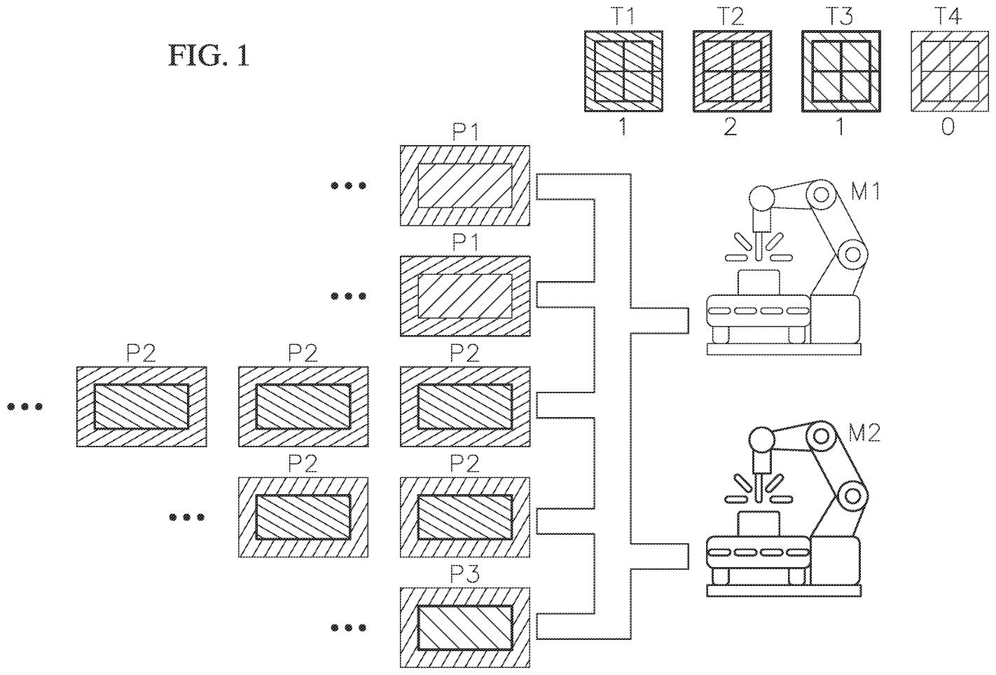

FIG. 1 depicts an example block diagram of a manufacturing facility. Referring to FIG. 1, the example manufacturing facility may have two machines M1 and M2 that may be configured to produce three different products P1, P2, and P3, and by using one or more of tools T1, T2, T3, and T4. In some embodiments, the machine may be, for example, a semiconductor fabrication machine and the tool may be a fabrication mask.

Thus, a product such as an electronic chip may be produced on one of the semiconductor fabrication machines by using one of the masks. In other cases, a machine may more than one tool (e.g., two tools) to product a certain product, or in yet another case, two different machines may need to be used to produce a single product. Therefore, according to some techniques, a human such as a factory manager or a manufacturing manager may determine a human-based scheduling policy that sets the order in which the machines should be utilized to by taking into consideration various factors such as, for example, the number of products that need to be produced, the amount of time it takes to produce a certain product, the availability of the machines, the availability of the raw materials, prioritization and demands of certain products over other products, etc. However, as the complexity of the manufacturing process increases, for example, because of the number of different products that are produced by the facility, the number of machines, and/or more complex manufacturing processes for the products, it may become more difficult for a human-based process to determine an optimal manufacturing policy. Therefore, reinforcement learning (RL)-based scheduling techniques may be utilized in addition to, or instead of a human-based scheduling technique to generate efficient scheduling policies for the manufacturing facility.

To ensure optimal operation of the facility, the factory may employ a set of evaluation metrics or criteria to assess the schedule quality that is provided by the scheduling policy. For example, the quality may be determined by calculating a weighted sum of such criteria using the equation: E=Σ_{i=1, . . . ,n}αᵢeᵢ, where ||α·||=1. The terms “evaluation metrics” may be defined in the present disclosure as measurements (e.g., quantifiable measurements) that may be utilized to determine effectiveness or productivity. Some examples of such metrics include key performance indicators (KPIs).

However, the evaluation metrics may be dynamic and undergo frequent and/or continuous changes. For example, adjustments may be made to align with certain factory targets and/or goals. Furthermore, these adjustments may occur both during product development (i.e., when the machines are operating and making the products) and/or after development of the product (i.e., when the machines are idle and/or making other products). Thus, some of the evaluation value eᵢ may not be obtained immediately during execution, but rather it may be obtained after a period of time. Such adjustments may encompass a set of criteria, evaluation weights, and related factors. These evolving criteria may not be pre-modeled as a reward during an RL training or optimization process.

Consequently, the scheduling policies that are trained using previous reward functions are no longer optimized for the updated evaluation metrics, and in some instances may even lower performance. Thus, the robustness and optimal performance of the scheduling policy during deployment may not be guaranteed when the evaluation metrics' weights are subject to modification. Therefore, a holistic pipeline is desired such that the system can identify whether the existing policy is compatible with the new criteria, or whether the RL-based scheduler (e.g., RL agent) needs to be retrained with new policies such that optimal performance may be guaranteed. Therefore, various proxy stage reward rᵢ ∈[0,1] may be utilized to approximate the evaluation item eᵢ by using the equation R=Σi=1, . . . ,nβᵢrᵢ, wherein ||β·|=1 to facilitate the learning of the RL agent toward final evaluation.

In some embodiments, it may first be desirable to determine whether the RL agent should be retrained with a new policy. This may be determined for example, by identifying conditions for the initiation of new policy training, developing criteria to assess the limitations of the existing policies, and then implementing a monitoring system for policy performance evaluation. In some embodiments, a robust policy subject to the changing evaluation metrics may be generated by designing an adaptive policy architecture that can be generalized across multiple weights over time, and such that the robustness of such policy may be ensured under variable evaluation weights. Finally, if it is determined that the RL agent needs to be trained with a new policy, the retraining process may be expedited and performed efficiently, for example, by performing only a partial retaining focusing only on the areas that need retraining, as opposed to performing a full complete retraining from the beginning. Accordingly, the above desires may be accomplished by first, determining the robustness zone of a policy that may assess whether the policy is sufficiently robust, given the evaluation metrics. In one or more embodiments, this may be accomplished by formulating metrics to evaluate the constraints of existing policies, and then implementing a monitoring system for policy performance evaluation. Herein the present disclosure, the term “policy” may be defined as a set of rules, guidance, or instructions, that are to be followed in performing a task.

Thus, for example, a policy such as “first come first served” means that the first person (or thing) that comes is the first person (or thing) that is served (or processed). Therefore, in the context of the embodiments of the present disclosure, a policy for a machine in a factory may be a set of rules that govern when the machine is to run and when the machine is to be idle or off, and/or what product the machine is to produce. Yet, in a further example, the policy may be implemented in a module (e.g., a computing module including a neural network) that may take various parameters such as queue length and arrival time, and then generate an output from the computing module an assigned priority for each job that a particular machine is going to perform. Hence, the jobs may be selected to be processed according to the assigned priority. The terms “robust” and “robustness” may be defined as a policy that is capable of operating optimally. Therefore, the terms “robustness zone” may be defined as a policy that is robust, or a set of environments that the policy is robust. Furthermore, the terms “deploy” or “deployment” as used in the present disclosure is intended to mean that a given policy is implemented on a machine or other manufacturing devices, tools, and/or industrial computers on-site, in a facility so that the machine may operate in according with the deployed policy.

While embodiments of the present disclosure are described in more detail hereinafter in the context of robustness scheduling policies for coordinating various manufacturing processes and the like for the machines M1, M2, the present disclosure is not limited thereto. For example, the systems and methods described herein may be applicable to any suitable systems and methods that may benefit from generating a new combination of existing policies for a new reward function. In other words, as long as there is a policy that takes in some parameters/factors and outputs a decision/action, it can be combined with another policy according to one or more embodiments of the present disclosure. For example, the systems and methods described in more detail hereinafter may be applicable to various robotic control applications, navigation systems, autonomous driving applications, large language model training, and the like.

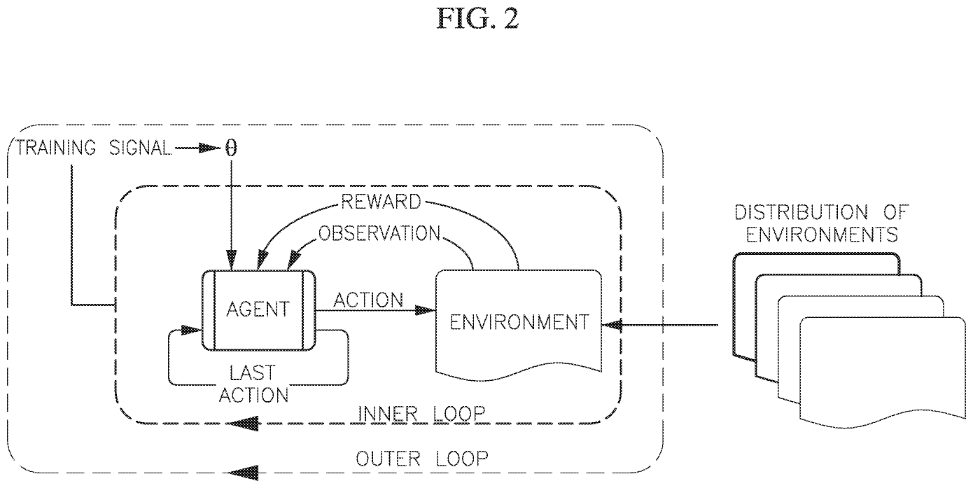

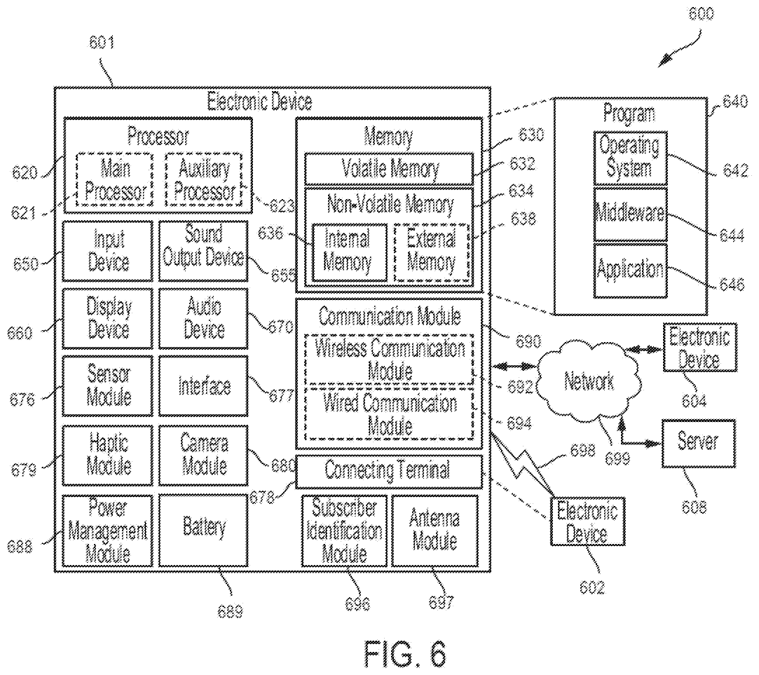

FIG. 2 is a block diagram of a reinforcement learning (RL) system, according to one or more embodiments of the present disclosure. The RL system 200 may be modeled as a Markov Decision Process (MDP) and may include an agent 202 and an environment 204. Each of the agent 202 and the environment 204 may be implemented, for example, as instructions stored in memory and executed by one or more processors (e.g., the processor shown in FIG. 6). Applying the RL system 200 to the manufacturing facility scheduling policies described above, the agent 202 may be a scheduler (e.g., an RL-based scheduler) configured to receive inputs (e.g., a set of environment and agent states S, and reward R), that cause action A (e.g., which product to process next) to the environment 204, which may be a factory (e.g., the manufacturing facility including the machines and tools). The environment 204 may then output a reward R based on the action A (e.g., the factory may output a reward that indicate whether the selection was a good or not good). The environment 204 may include various parameters such as the state S of the environment, and accordingly, a scheduling policy generates an output that indicates the order in which the product should be processed. Accordingly, the agent 202 may be provided with continual feedback from the environment 204 so that the agent 202 may continuously improve the policy output that it generates.

Turning now to the reward function, in some embodiments, the manufacturing facility may have various key performance indicators (KPIs) that are to be achieved in order to meet their goals, for example, production goals to meet customer demands or business goals, and objectives. A factory manager may be in charge of the operations in the manufacturing facility and may desire to adjust production based on new goals and/or targets to meet certain KPIs (e.g., new KPIs that were improved on the factory manager by the management). Thus, the scheduling agent (e.g., RL-based scheduling agent) may improve its ability to schedule through a reinforcement learning process. In some embodiments, this may be achieved by obtaining as much reward as possible as: R=Σ_{i=1, . . . ,n}βᵢrᵢ wherein ||β·||=1, where β corresponds to reward coefficient or weight coefficient, R corresponds to total reward, and r corresponds to sub-rewards. Thus, total rewards R may include pluralities of sub-rewards r. For example, the sub-rewards r may be based on, and may include the number of the products that are processed, the number of the high priority jobs that have been processed, the types of tool used to make the product (e.g., the mask that is used for semiconductor fabrication because changing the mask can take time), and job-type change because of the amount of time it takes to set up the machines for the new job-type, with the reward coefficient being set to 1.

In some embodiments, quick adaption may be performed, such that given the MDP environment where the reward function is defined based on reward coefficient β, a policy is determined that is able to quickly adapt to a set of the MDPs where the reward function is changing. In other words, the policy is able to converges to optimality within a limited amount of training budget, e.g., time and computational resources. This may be shown as:

$$Max E [ \sum {R}_{{π}^{′}}^{′} ]$$

$${R}_{{π}^{′}}^{′} = \sum {β}^{′} {r}_{{π}^{′}}$$

$$where {‖ β \cdot - β {\cdot }^{′} ‖}_{p} \leq ϵ ( {‖ {δ}_{β} ‖}_{p} \leq ϵ )$$

$$where {π}^{′} ← 〈 S , A , {R}^{′} , P 〉 , π ← 〈 S , A , R , P 〉 .$$

Thus, β is within a perturbation of ∈ on β. That is, the difference between β· and β·′ is less than a threshold and the P is the LP norm. Here, the threshold E may correspond to the robustness zone. In other words, as long as the difference between β· and β·′ is less than the threshold, robustness may be guaranteed for the policy and the average policy of the training policy may be quickly adapted to the new environment within this area. It should be noted that when p=1, then β· minus β·′ is an absolute value. If p=2, then then β· minus β·′ is the mean square of the difference. In some embodiments, this may be solved by a meta learning methodology shown as:

$$Meta MDP {M}_{j} ∼ M$$

$${M}_{j} = 〈 S , A , {R}_{j} , P 〉$$

$${R}_{j} = \sum {β}_{j} r$$

$$where {‖ {β}_{j} - β ‖}_{p} \leq ϵ .$$

Thus, meta learning may include sampling a plurality of MDPs from a distribution of β· as described above, and perform meta learning using the above-described reinforcement learning paradigm as shown in FIG. 2 to generate an output π.

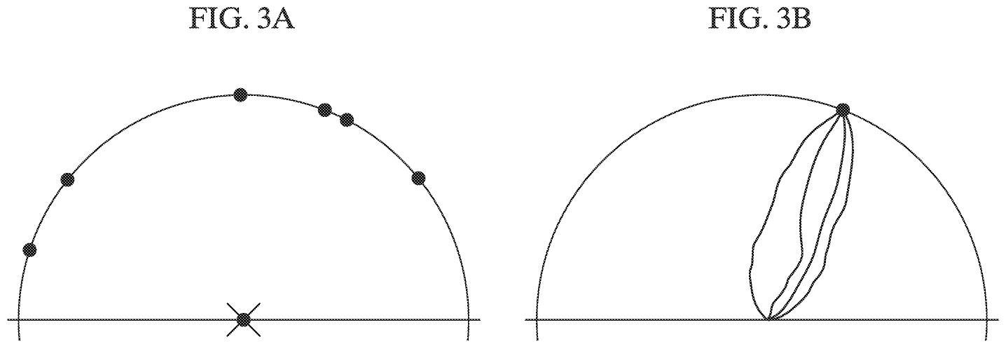

During the deployment for quick adaption, the new environment using the meta policies may be adapted. For example, FIG. 3A depicts a set of meta-policy π trained with E_{M}_{ⱼ}_{˜M}[E_{π}Jⱼ(_{π})], wherein the centroid X represents a policy obtained from a plurality of MDP environments shown as dots along a perimeter of the semicircle. Then during deployment, when a new β is found, a new MDP environment may be quickly achieved starting from the centroid X of the circle as shown in FIG. 3B. Accordingly, the scheduling policy may quickly go to the targeted policy, which corresponds to the optimized policy.

In some embodiments, robustness of the policies may be evaluated. As previously discussed, the policies include an MDP environment with a specific reward function R with β<S, A, R, P>⇒π. The summation of the R and β(ΣR_{β′},) may generate the total reward R, and the MDP may be trained such that it has a certified robustness that is subject to adversarial β′. Certified robustness certifies that a model is sufficiently robust to adversarial examples when its prediction result is stable when small perturbations are applied to the input. The model may have an upper bound of the model loss due to the perturbation of the parameters. In other words, a lower bound of model's prediction accuracy or prediction performance may be defined when considering an adversarial perturbation with bounded magnitude. Thus, certified robustness may be analogized to an adversarial game for policy π that is trying to maximize the total reward it can achieve through the MDP environment, which may be shown as: min_{β′}, max_{π}ΣR_{β′·}, while another agent (i.e., adversarial agent) is trying to tune around the β such that it can minimize the rewards that the agent can get. This may be shown as: R′=Σβ′r. Accordingly, an adversarial game occurs where one side attempts to reduce the productivity of the factory while the other side attempts to improve productivity of the factory by varying the KPIs and/or the reward coefficients, within the constraints: where ||β·−β·′||ₚ≤∈(||δ_{β}||≤∈).

As discussed above, adversarial reinforcement learning may refer to an opponent agent who's objective is to reduce e.g. minimize) the factory's target, given by the equation:

$${min}_{{β}^{′}} \sum {R}^{′} , {M}^{′} = 〈 S , A , {R}^{′} , P 〉 , {R}^{′} = \sum {β}^{′} r ,$$

with a constraint for β′ shown as: |δ_{β}|ₚ≤∈. On the other hand, the schedule agent has an objective of increasing (e.g., maximize) the total reward that it can receive, shown by the equation:

$${max}_{π} \sum {R}^{′} .$$

Consequently, a game is created such that the output of the game through the adversarial reinforcement learning provides us the β adversarial (β_{adv}) and π adversarial (π_{adv}) shown by the equation:

$${β}_{adv} , {π}_{a d v} ← {min}_{β} {max}_{π} \sum {R}^{′} .$$

Here, β_{adv} corresponds to the best that the opponent agent can play and the π_{adv} corresponds to the policy it can generate that guarantees performance that satisfies a certain threshold (e.g., satisfies a minimum performance). Accordingly, a robust performance gap (ΔΣR_{β}) may result, and therefore be identified by computing the difference between the worst performance that can result from the policy (ΣR_{β,π}_{_{adv}}) and the performance that is achieved without any adversarial attack (ΣR_{β,π}_{_{β}}), shown by the equation: ΔΣR_{β}=ΣR_{β,π}_{_{adv}}−ΣR_{β,π}_{_{β}}. In other words, the robust performance gap is the worst-case scenario for the scheduling agent after an adversary attempts to adversely tune the threshold. Then, a performance gap vs. epsilon gap matrix may be obtained such that the epsilon is maintained less than a threshold T shown by the equation: ∈_{β}s.t. ΔΣR_{β}<T. In some embodiments, the threshold T may be a threshold that is determined or set by the factory manager to meet various KPIs and/or goals. In one example, the threshold T may be based on production goals where the total throughput shall not drop by more than 1%. In such case, the threshold T may be set so that the throughput will never drop by more than 1%, and the robustness guarantees that the throughput will not drop by more than 1%. It should be noted that this threshold is just one example and that other production goals and/or KPIs may be considered in setting the threshold T.

In some embodiments, techniques for meta learning and robustness may be incorporated into a framework to perform operations in a manufacturing facility according to one or more embodiments of the present disclosure.

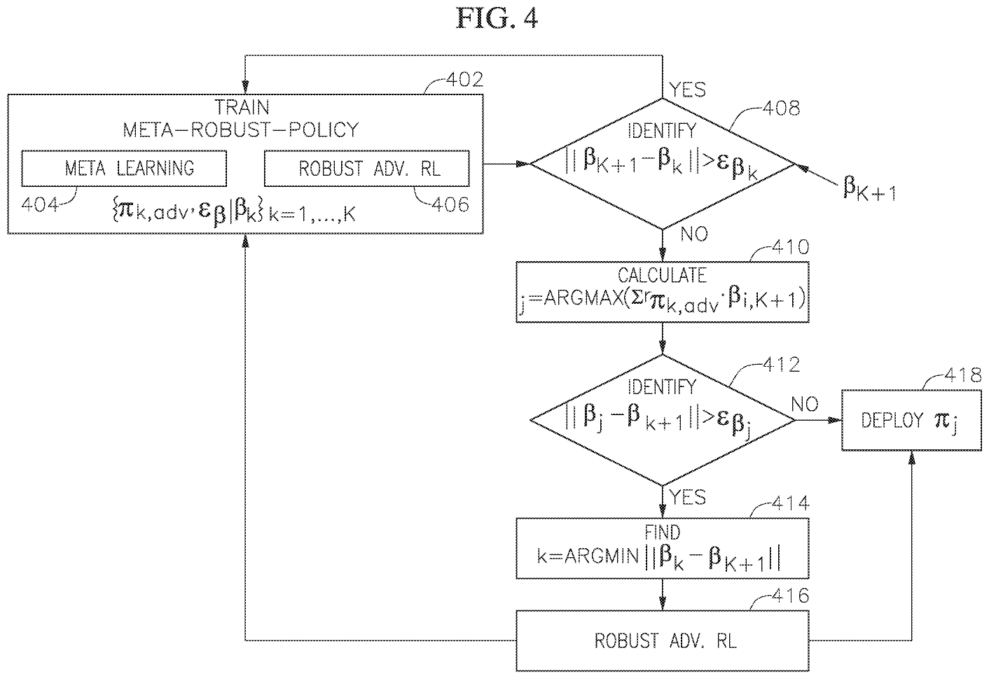

FIG. 4 is a flow chart of a method for evaluating scheduling policies, according to one or more embodiments of the present disclosure. In some embodiments, meta robust policy may be trained at step 402 by combining meta learning 404 and robust adversarial reinforcement learning 406. In the present disclosure, “meta learning” may refer to a policy that may quickly adapt to new and different scenarios, and “robust adversarial reinforcement learning” may refer to a policy that is robust such that the policy stays within certain thresholds. Accordingly, the meta learning policies and robust adversarial RL policies may be combined to train meta robust policy at step 402, which may be calculated as: {π_{k,adv,} ∈_{β}_{ₖ}|βₖ}_{k=1, . . . ,K}, given βₖ.

In some embodiments, the meta robust policy may be calculated offline, for example, separately from the manufacturing facility on a computer system or a server as described in FIG. 6. Next, based on the calculated meta robust policy, a matrix of the reward for each policy may be obtained as:

$$\sum {r}_{{i}_{{π}_{k , adv}}}$$

(n×K matrix), β_{i,k} (n×K matrix). Thus, for each k policy, a reward R and reward coefficient βₖ may be generated. Next, given the meta robust policy from step 502, and based on new evaluation metrics that may be entered into the system, for example, from the factory manager based on new KPIs or objectives, shown as β_{K+1} in FIG. 4, the change of the evaluation metrics may be calculated as: ||_{K+1}−βₖ||>∈_{β}_{ₖ}, ∀k, to identify whether the new evaluation metrics is larger than thresholds ∈_{β}_{ₖ} at step 408.

If the new policies based on the new evaluation metrics is larger than the threshold, then none of the k policies may have a guaranteed robustness and a full retraining will be performed as: M=<S, A, Σβ_{K+1} r, P>with β_{K+1}. On the other hand, if at least one of the k policies is smaller than the threshold, then a policy that can obtain the optimal (e.g., maximum) performance under the new weight may be calculated as:

$${π}_{j} = arg max ( {\sum }_{i = 1 , … , n} \sum {r}_{{i}_{{π}_{k , adv}}} \cdot {β}_{i , K + 1} ) .$$

In this case, the retraining does have necessarily have to be done from the beginning but instead, only a partial retraining may be performed at step 410.

In some embodiments, if the difference between the reward coefficient for j (βⱼ) and the reward coefficient under the new weight k+1 (f_{K}+1) is greater than the threshold, shown as: ||βⱼ−β_{K+1}||>∈_{β}_{ⱼ}, then a full training from the beginning is not needed but instead the policy may simply be fine-tuned from the meta policy πₖ, where k=argmin||βₖ−β_{K+1}|| at step 412. Accordingly, the policy may be fine-tuned at steps 414 and 416, after which the policy may be deployed at step 418. On the other hand, if the difference between the reward coefficient for j (βⱼ) and the reward coefficient under the new weight k+1 (β_{K+1}) is less than the threshold, then the policy may be deployed at step 418 because the robustness has already indicated that a high performance (e.g., optimal performance) may still be achieved even under the new evaluation metrics.

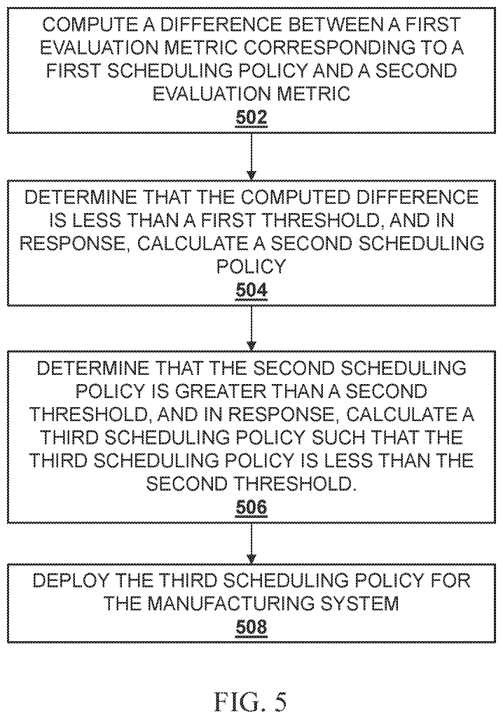

FIG. 5 is another flow chart of a method for evaluating robustness scheduling policies, according to one or more embodiments of the present disclosure. In some embodiments, a manufacturing system may include a processor and a memory storing instructions, that when executed by the processor, causes the processor to perform computational steps to evaluate the robustness scheduling policies. According to a first step, the processor may compute a difference between a first evaluation metric corresponding to a first scheduling policy and a second evaluation metric (step 502). Based on this computation, if the processor determines that the computed difference is less than a first threshold, then in response, a second scheduling policy may be calculated (step 504). In some embodiments, the first threshold may be ∈_{β}_{ₖ} shown at step 408 in FIG. 4. Furthermore, in some embodiments, the first scheduling policy may be {π_{k,adv}, ∈_{β}_{ₖ}|_{β}_{ₖ}}_{k=1, . . . ,K} shown at step 402 in FIG. 4 and the second scheduling policy may be β_{K+1} shown at step 408 in FIG. 4. Next, the processor may determine whether the calculated second scheduling policy is greater than a second threshold, wherein the second threshold may be ∈_{β}_{ⱼ} according to some embodiments, as shown at step 412 in FIG. 4, and in response to determining that the second scheduling policy is greater than the second threshold, calculate a third scheduling policy such that the third scheduling policy is less than the second threshold (step 506). In some embodiments, the third scheduling policy may be the fined-tuned policy at steps 414 and 416 in FIG. 4. Accordingly, a robustness scheduling policy may be deployed by the manufacturing system (step 508).

FIG. 6 is a block diagram of an electronic device in a network environment 600, according to one or more embodiments of the present disclosure. As will be described, one or more systems, devices, modules, and/or components may be implemented in the manufacturing facilities described above, to facilitate the operations of the production process. For example, a semiconductor fabrication machine may include the one or more systems, devices, modules, and/or components described and shown in FIG. 6. Therefore, the policies may be implemented on the semiconductor fabrication machine together with other machines, tools, and devices in the facilities to optimally produce the various products.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

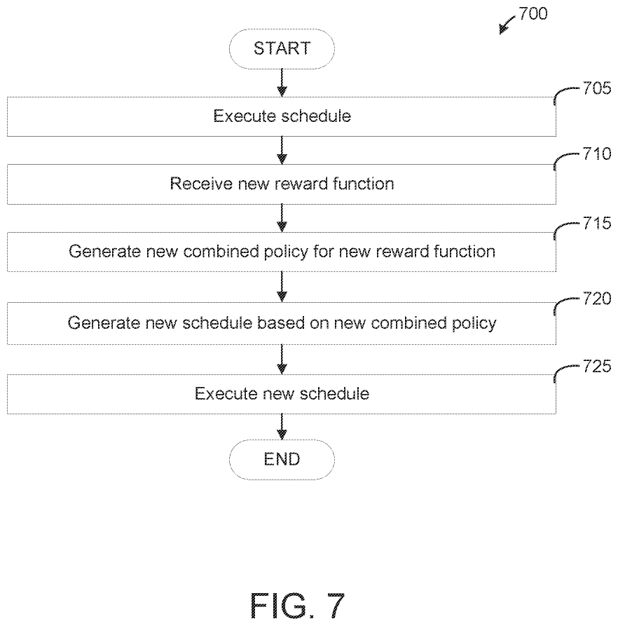

FIG. 7 is a flowchart of a method of executing a schedule according to one or more embodiments of the present disclosure.

The method 700 shown in FIG. 7, may be performed, for example, by the agent 202 described above with reference to FIG. 2. However, the present disclosure is not limited thereto, and the operations shown in the method 700 may be performed by any suitable one of the components and elements or any suitable combination of the components and elements of those of one or more example embodiments described above. Further, the present disclosure is not limited to the sequence or number of the operations of the method 700 shown in FIG. 7, and can be altered into any desired sequence or number of operations as recognized by a person having ordinary skill in the art. For example, in some embodiments, the order may vary, or the method 700 may include fewer or additional operations. Further, the operations shown in method 700 may be performed sequentially, or at least some of the operations thereof may be performed concurrently (e.g., simultaneously, or substantially simultaneously).

Referring to FIG. 7, the method 700 may start, and a schedule may be executed at block 705. For example, in some embodiments, the schedule may be executed to coordinate machine actions in a factory, schedule navigation tasks, coordinate language model tasks, and the like. A new reward function may be received at block 710. For example, in some embodiments, a new reward function corresponding to an evaluation criteria for the generated schedules may be received at block 710 (e.g., from a domain expert and the like).

A new combined policy may be generated for the new reward function at block 715. For example, the new combined policy may be generated for the new reward function as a parameterized (e.g., a weighted) combination of a plurality of existing policies based on the new reward function and the performance threshold criteria as discussed above with reference to the methods shown in FIGS. 4 and 5. As a result, a new schedule may be generated based on the new combined policy at block 720.

The new schedule may be executed at block 725, and the method 700 may end. For example, executing the new schedule at block 725 may include changing the order of machine operations, selecting different navigation tasks, changing an order of language model tasks, and the like, based on the new schedule.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims and their equivalents.

What is claimed is:

1. A manufacturing system comprising:
a processor; and
a memory storing instructions executed by the processor to cause the processor to:
compute a difference between a first evaluation metric corresponding to a first scheduling policy and a second evaluation metric;
determine that the computed difference is less than a first threshold, and in response, calculate a second scheduling policy;
determine that the second scheduling policy is greater than a second threshold, and in response, calculate a third scheduling policy such that the third scheduling policy is less than the second threshold; and
deploy the third scheduling policy for the manufacturing system.

2. The system of claim 1, wherein the computed difference being less than the first threshold is indicative of the first scheduling policy being in a first robustness zone based on the second evaluation metric.

3. The system of claim 1, wherein the first evaluation metric corresponds to a first set of key performance indicators (KPIs) and the second evaluation metric corresponds to a second set of KPIs.

4. The system of claim 3, wherein the instructions further cause the processor to compute the first scheduling policy, the first scheduling policy comprising combining a meta learning policy and a robustness adversarial reinforcement learning (RL) policy.

5. The system of claim 4, wherein the first evaluation metric comprises a first matrix, and the second evaluation metric comprises a second matrix.

6. The system of claim 1, wherein the second scheduling policy being greater than the second threshold is indicative of the second scheduling policy being outside of a second robustness zone.

7. The system of claim 1, wherein the second scheduling policy corresponds to a policy that causes a highest performance among other policies.

8. The system of claim 1, wherein the calculating the third scheduling policy comprises fine-tuning a meta learning policy.

9. A method, comprising:
computing, by a processor, a difference between a first evaluation metric corresponding to a first scheduling policy and a second evaluation metric;
determining, by a processor, that the computed difference is less than a first threshold, and in response, calculate a second scheduling policy;
determining, by a processor, that the second scheduling policy is greater than a second threshold, and in response, calculate a third scheduling policy such that the third scheduling policy is less than the second threshold; and
deploying, by the processor, the third scheduling policy.

10. The method of claim 9, wherein the computed difference being less than the first threshold is indicative of the first scheduling policy being in a first robustness zone based on the second evaluation metric.

11. The method of claim 9, wherein the first evaluation metric corresponds to a first set of key performance indicators (KPIs) and the second evaluation metric corresponds to a second set of KPIs.

12. The method of claim 11, further comprising computing, by the processor, the first scheduling policy, the first scheduling policy comprising combining a meta learning policy and a robustness adversarial reinforcement learning (RL) policy.

13. The method of claim 12, wherein the first evaluation metric comprises a first matrix, and the second evaluation metric comprises a second matrix.

14. The method of claim 9, wherein the second scheduling policy being greater than the second threshold is indicative of the second scheduling policy being outside of a second robustness zone.

15. The method of claim 9, wherein the second scheduling policy corresponds to a policy that causes a highest performance among other policies.

16. The method of claim 9, wherein the calculating the third scheduling policy comprises fine-tuning a meta learning policy.

17. A computer-readable medium storing instructions that, when executed by one or more processors, cause the one or more processors to perform a method comprising:
computing a difference between a first evaluation metric corresponding to a first scheduling policy and a second evaluation metric;
determining that the computed difference is less than a first threshold, and in response, calculate a second scheduling policy;
determining that the second scheduling policy is greater than a second threshold, and in response, calculate a third scheduling policy such that the third scheduling policy is less than the second threshold; and
deploying the third scheduling policy.

18. The computer-readable medium of claim 17, wherein the computed difference being less than the first threshold is indicative of the first scheduling policy being in a first robustness zone based on the second evaluation metric.

19. The computer-readable medium of claim 17, wherein the one or more processors performs a method comprising computing the first scheduling policy, the first scheduling policy comprising combining a meta learning policy and a robustness adversarial reinforcement learning (RL) policy, and
wherein the first evaluation metric corresponds to a first set of key performance indicators (KPIs) and the second evaluation metric corresponds to a second set of KPIs.

20. The computer-readable medium of claim 17, wherein the second scheduling policy being greater than the second threshold is indicative of the second scheduling policy being outside of a second robustness zone,
wherein the second scheduling policy corresponds to a policy that causes a highest performance among other policies, and
wherein the calculating the third scheduling policy comprises fine-tuning a meta learning policy.
